(19) United States
(12) Patent Application Publication
(10) Pub. No.: US 2022/0061231 A1
(43) Pub. Date: Mar. 3, 2022

(54) PLANT SUPPORT CAGE

(71) Applicant: Gretchen Fahey, Visalia, CA (US)

(72) Inventor: Gretchen Fahey, Visalia, CA (US)

(21) Appl. No.: 17/007,571

(22) Filed: Aug. 31, 2020

(51) Int. Cl. A01G 9/12; A01G 22/05; A01G 22/60

(52) U.S. Cl. CPC A01G 9/12; A01G 22/60; A01G 22/05

(57) ABSTRACT

The present invention provides a growing support structure for use in planting crop and ornamental plants which supports the growth of the plant and may improve fruit production. The tool is a cage structure through which the plant grows, propping up the shoots of the plant and supporting the fruit, flowers, and/or other anatomical structures, keeping them from contacting the ground, thereby preventing rot. The cage structure also allows the plant to still receive the benefit of sunlight, as the cage allows the passage of sunlight.

### FIELD OF THE INVENTION

The present invention relates to improved growing structures for crops and ornamental plants and related methods. More specifically, the present invention relates to a cage structure for supporting and improving the growth of low-lying, fruit-bearing plants, and methods of using the same.

### DISCUSSION OF THE BACKGROUND

Many plants require support during the growth, flowering, and vegetable producing periods. As some plants grow, they are unable to support their own weight. This is problem particularly applies to low-lying crop plants, such as tomatoes, berry plants, cucumbers, and others. Traditionally, gardeners and farmers attach the plants to a stake driven into the ground. This technique is tedious, labor intensive, and is not particularly effective in optimizing the plant's growth.

There are existing structures other than stakes used to support plant growth, such as racks, trellises, and others which have limited adjustability for short or tall plants. Devices for supporting low-lying plants are particularly lacking. Low-lying crop plants typically lose significant amounts of yield due to the fruit contacting the ground and either get eaten by insects and other pests, or rot due to fungal and bacterial infection. Therefore, improved plant support structures are needed.

### SUMMARY OF THE INVENTION

The present invention provides a plant support cage that prevents or reduces the plant, and the fruit, vegetables, or flowers it produces from contacting the ground, thereby avoiding rot and consumption by pests. The presently disclosed plant support cage is particularly directed toward low-lying fruit-bearing plants, such as strawberries and tomatoes that are typically grown on elevated mounds without any support frames or structures. The presently disclosed cages are easily and efficiently installed in the soil, having relatively short and robust insertion rods that can be quickly inserted into the ground. The plant support cage has a plurality of frame windows through which shoots of the plant can pass, and the structure members of the window (e.g., wires, rods or bars) can support the shoots of the plant when they are laden with fruit, vegetables or flowers, preventing the shoots from sagging toward the ground. The present invention also provides a plant support that is durable and long lasting, and can be repeatedly used for multiple growing seasons.

The plant support of the invention is comprised of vertical members and cross members which may be made of steel, plastic, galvanized wire or any material substantially rigid and durable. The first set of vertical support members are located at each corner and have bottom ends that are adapted to engage with the soil to anchor the plant support in place. The first set of cross members connect the upper ends of the vertical corner support members in series. The second set of vertical support members branch off the first set of cross members and are placed at predetermined distances from the upper end of the vertical corner support members. The second set of cross members alone comprise the central frame window and completes the formation of the rest of the frame windows once connected to the upper ends of the vertical support members. Certain members, such as the first set of cross members, may have notches or indents that further increase plant and/or cage support and stability. The resulting structure is compact and robust with short parallel insertion rods that enable the cage to be quickly installed along a crop row fairly easily with little manual labor compared to traditional methods.

The plurality frame windows in the present invention allow the passage of light and supports the plant by providing areas to rest plant shoots, fruit, flowers, and/or other anatomical structures. The cross members and vertical members of the frame may support the weight of adjacent plant shoots and subsequently hold the plant in place, and may fortify the stem when subject to external forces from the environment (e.g., wind). This keeps the plant structures stable and elevated, enabling them to avoid the ground and consequently protecting them from rot and pest consumption. This also alleviates the need for plants to be grown on mounds; the cage enables the plants to be grown on flat ground without the concern of fruit becoming submerged in irrigation water or falling over.

The plant support cage may be low-profile, simulating the height of the typical crop row mounds that are used for low-lying plants such as strawberries. The height of the plant support cage may be in a range of about 4 inches to about 12 inches, provided that the cage maintains its compact and rigid structure. The width of the plant support cage may be in a range of about 6 inches to about 15 inches. The length of the plant support cage may be in a range of about 10 inches to about 24 inches. The width and length of the plant support cage may vary in order to accommodate the desired size of the plant for facilitating spacing along a crop row or to support the typical size and growth pattern of the particular plant. It is to be understood that the frame windows may have other suitable shapes or sizes that allow for easy passage of the plant's shoots and provide support. The dimensions of the plant support cage may vary depending on, but not limited to, the plant, the climate, or the incline of the ground.

The plant support cage may have frame windows that support the plant. The shoots of the plant grow through the frame windows, which support the plant and keep the shoots and flowers or fruit thereon from contacting the ground. The plant support cage may include lateral frame windows between the first and second sets of horizontal support members. The lateral frame windows may have a polygonal shape and varying sizes having widths in range of about 2 inches to about 5 inches and heights of about 2 inches to about 4 inches. The lateral frame windows have a sufficient size to allow passage of shoots therethrough, while also having sufficient narrowness to support a drooping shoot without allowing the shoot to droop more than about 1-2 inches before contacting the one of the first horizontal members. Larger lateral windows that allow the shoots to droop more than about 1-3 inches can sustain damage due to pinching or kinking in the shoot. The lateral windows of the present invention are sized to excessive drooping that may lead to the kinking of the shoot, which results in the distal portion of the shoot falling near or to the ground. The plant support cage includes anterior and distal ends of the cage that may feature one or more lateral windows with vertical supports that have a convex outward bend therein defining the lateral sides of the windows. These outward bends may assist in preventing inward collapse of the cage, and provide further structural support. The plant support cage may also include lateral windows at one or more of the corners of the cage that have a three-dimensional polygonal structure due to the convex outward bend in the vertical supports of the end windows adjacent thereto. The one or more corner windows may also have an acute angle in a corner portion from which the insertion corner rod is attached. The acute angle assists in preventing inward collapse of that corner portion of plant support cage, and provides further structural support.

The plant support cage may also include vertical frame windows between the second cross members that allow shoots near the center of the plant to grow substantially vertical therethrough. The plant support cage may include at least two vertical frame windows. The vertical frame windows may be larger in size than the lateral frame windows because (1) it is preferred that the shoots grow in a more vertical orientation to keep the shoots away from the ground, and (2) shoots in a substantially vertical orientation are less prone to kinking and pinching as the weight vector of the shoot and any fruit thereon are directed substantially along the axis of the shoot rather than the weight applying a shear force to the shoot. The plant shoots are stronger along their axes and can thus better support their own weight and the weight of any fruit when in a more vertical orientation. The vertical frame windows may have a generally rectangular shape formed by the second cross members. When the plant support cage is installed in flat ground the plane on which the vertical frame windows sit may be substantially horizontal, such that the opening of the windows allows vertically oriented shoots of the plant to pass. The vertical frame windows may have varying sizes having widths in range of about 4 inches to about 14 inches and length of about 4 inches to about 11 inches. It is to be understood that it is contemplated that additional cross members may be added to the vertical frame windows to divide them into smaller windows and provide additional shoot support. It is to be understood that the vertical frame windows may also have other perimeter shapes, such round, elliptical, or other polygonal shapes.

The present invention also includes a method of growing low-lying plants, such as fruit-bearing plants using the plant support cages disclosed herein, which facilitates growing such plants on flat ground without the plants or fruit being damaged by contact with ground or pooled irrigation water. The method may include preparing a substantially flat area of soil for growing plants, planting one or more low-lying plants (e.g., strawberry plants, tomatoes, etc.) in the prepared soil, waiting for the plant to sprout, and placing the plant growing cage over the one or more low-lying plants. The windows in the plant growing cage are arranged in an encompassing pattern that capture the shoots of the one or more fruit-growing plants, including those that grow semi-laterally, as the lateral windows have lower borders that are close to the ground. The windows may then support and train the shoots of the plant to prevent growth too near the ground. A plant-growing cages can be efficiently inserted into the prepared soil (e.g., creating a crop row) as the cage requires only vertical motion to insert the vertical insertion rods into the soil.

Once the plants have grown fruit, the cages support the fruit-bearing shoots, such that the fruit remains suspended over the ground, avoiding contact with the soil and pooled irrigation water, thereby avoid spoilage of the fruit. The fruit may be harvested, and the yield from the plants may be improved as fewer fruit have wasted on the ground. Once the fruit have been harvested, the plant support cages can be quickly removed from the soil by simply vertically lifting the cage. The cages can then be efficiently stored by stacking one upon another as each cage has the same concave construction allowing for stacking.

The following paragraphs discuss exemplary embodiments and implementations of the present invention and exemplary objects of the present invention. These descriptions are intended to further explain the invention, but do not limit the scope of the present invention.

In one aspect of the present invention is drawn to a low-profile plant support device for supporting growth of low-lying plants, comprising a plurality of corner insertion rods for insertion into soil; a plurality of lateral shoot-support windows operable to allow the passage of shoots of a low-lying plant to support the weight of the shoot and prevent kinking of the shoots; and at least one upward facing window operable to train vertical growth of shoots therethrough and reduce lateral collapsing of the shoots, wherein the plurality of lateral windows and the at least one upward facing window are operable to support the weight of shoots bearing fruit. The device may have a vertical height in a range of about 5 inches to about 12 inches. The device may further have a substantially rectangular outline. The plurality of vertical supports and cross members may have notches or indentations that further increase plant and/or device stability. The plant support device may include at least six lateral shoot-support windows. The plant support device may include at least eight lateral shoot-support windows. The plant support device includes vertical supports on at least one side that have a convex outward bend therein to assist in preventing inward collapse of the plant support device. The lateral shoot-support windows comprise at least one corner shoot-support windows located at a corner of the plant support device having a three-dimensional polygonal structure. The three-dimensional polygon structure may have an acute angle in a corner portion from which the one of the insertion corner rods may be attached, wherein the acute angle assists in preventing inward collapse of the corner portion of the plant support device. The at least one upward facing window may comprise a plurality of upward facing windows.

In a second aspect, the present invention may be drawn to a method of growing low-lying plants, comprising planting seeds of low-lying plants on substantially flat soil; placing a plant-support cage over the seeds or sprouts of the low-lying plants, the plant-support cage comprising a plurality of corner insertion rods for insertion into soil, a plurality of lateral shoot-support windows operable to allow the passage of shoots of a low-lying plant to support the weight of the shoot and prevent kinking of the shoots, and at least one upward facing window operable to train vertical growth of shoots therethrough and reduce lateral collapsing of the shoots, wherein the shallow corner insertion rods can be quickly inserted into the soil with application of a downward force of about 10 pounds or less; harvesting the low-lying plants; and removing the plant-support cages. The method may further comprise stacking the plant-support cages in a nesting manner, wherein the plant-support cages have a geometry that allows a plurality of the plant-support cages to be stacked in a nested manner. The vertical height of the plant-support cage may be in a range of about 5 inches to about 12 inches. The plant-support cage may have a substantially rectangular outline. The plurality of vertical supports and cross members may have notches or indentations that further increase plant and/or device stability. The plant support device may include at least six lateral shoot-support windows. The plant support device may include at least eight lateral shoot-support windows. The plant support device may include vertical supports on at least one side that have a convex outward bend therein to assist in preventing inward collapse of the plant support device. The lateral shoot-support windows may comprise at least one corner shoot-support windows located at a corner of the plant support device having a three-dimensional polygonal structure. The three-dimensional polygon structure may have an acute angle in a corner portion from which the one of the insertion corner rods is attached, wherein the acute angle assists in preventing inward collapse of the corner portion of the plant support device. The at least one upward facing window comprises a plurality of upward facing windows.

It is an object of the present invention to provide a plant support cage that prevents or reduces ground contact of the plant's anatomical structures thereby avoiding rot and consumption by pests.

It is an object of the present invention to provide a support cage that alleviates the need to grow plants on elevated mounds as opposed to flat ground without the concern of submersion in irrigation water or plant stability.

It is an object of the present invention to provide a plant support cage provides shoot support windows that prevent or reduce the tendency of shoots of the plant to grow or limp horizontally, which may result in kinking and damage to the shoots.

It is an object of the present invention to provide a plant support cage that's compact, rigid and has parallel insertion rods that enable it to be easily and quickly installed in a crop row.

It is an object of the present invention to provide a method of installing and de-installing plant support cages and growing low-lying crops in flat ground conditions that prevents or reduces the problem of submersion of fruits, flowers, or shoots in irrigation water and contact with the ground, thereby reducing the incidence of rot.

It is an object of the present invention to provide a plant support cage provides shoot support windows that prevent or reduce the tendency of shoots of the plant to grow or limp horizontally, which may result in kinking and damage to the shoots.

Further objects and aspects of the present invention will be apparent from the description provided herein.

### BRIEF DESCRIPTION OF THE DRAWINGS

FIG. 1 shows an isometric view of the plant support structure, according to an embodiment of the present invention.

FIG. 2 shows a view of the front side of the plant support structure, according to an embodiment of the present invention.

FIG. 3 shows a view of the back side of the plant support structure, according to an embodiment of the present invention.

FIG. 4 shows a view of the left side of the plant support structure, according to an embodiment of the present invention.

FIG. 5 shows a view of the right side of the plant support structure, according to an embodiment of the present invention.

FIG. 6 shows a top perspective view of the plant support structure, according to an embodiment of the present invention.

FIG. 7 shows a bottom perspective view of the plant support structure, according to an embodiment of the present invention.

FIG. 8 shows an isometric view of the plant support structure supporting a plant, according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

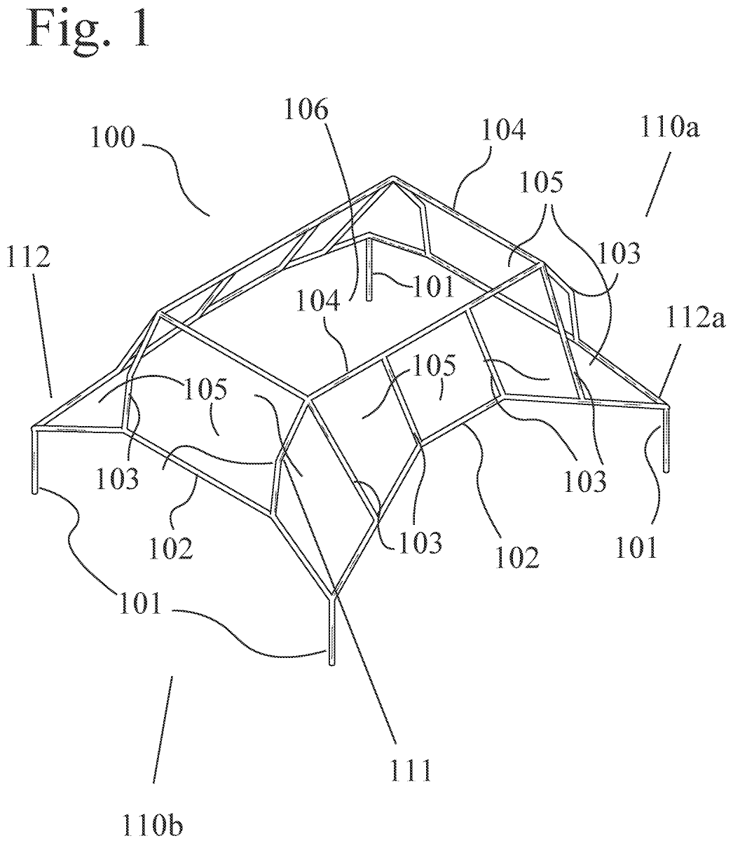

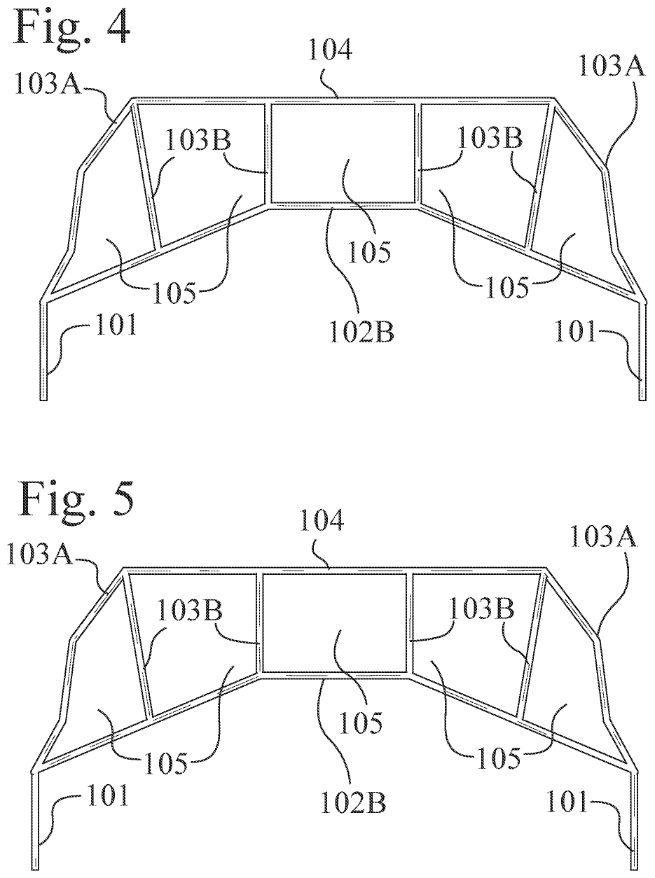

As shown in FIGS. 1-8, the present invention includes vertical members 101 and 103 and cross members 102 and 104 which may be made of steel, plastic, galvanized wire or any material substantially rigid and durable. The first set of vertical support members 101 are located at each corner and have bottom ends that are adapted to engage with the soil to anchor the plant support to the soil. The first set of cross members 102 connect the upper ends of the vertical corner support members and form the bottom side of windows 105, which are arranged in a row around the lateral sides of the cage 100 near the ground.

A second set of vertical support members 103 extend vertically from the first set of cross members 102. The support member 103 form the lateral borders of the windows 105, and are placed at predetermined spacing between therebetween such that windows have a substantially uniform area. The support members 103 are spaced at a relatively close distance in order to provide the frame of the cage 100 sufficient vertical structural integrity to support the shoots of the low-lying plants growing therethrough. The support members 103 may be spaced apart from one another at a distance of about 2 inches to about 5 inches.

The plant support cage includes anterior and distal ends 110a and 110b of the cage 100 that may feature one or more lateral windows 105 with vertical supports that have a convex outward bend 111 therein defining the lateral sides of the windows 105. These outward bends 111 may assist in preventing inward collapse of the cage 100, and provide further structural support. The plant support cage 100 may also include lateral windows 105 at one or more of the corners 112 of the cage 100 that have a three-dimensional polygonal structure due to the convex outward bend in the vertical supports of the end windows 105 adjacent thereto. The one or more corner windows 105 may also have an acute angle 112a in a corner portion from which the insertion corner rod is attached. The acute angle assists in preventing inward collapse of that corner portion of plant support cage, and provides further structural support.

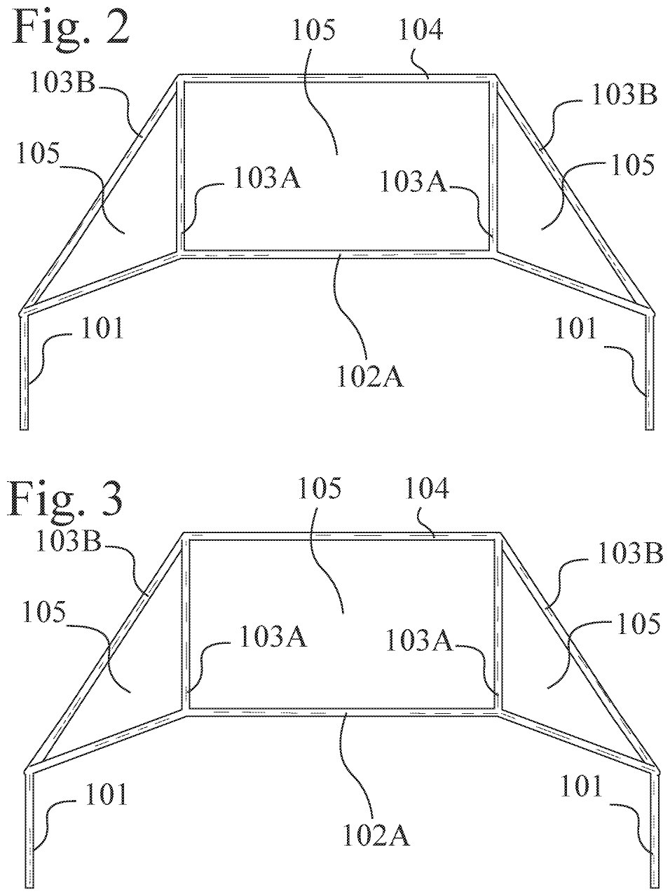

A second set of cross members 104 frame an upper central frame window 106 and completes the formation of the cage 100. The cross members 104 also provide the upper border of the lateral windows 105 once connected to the upper ends of the vertical support members 103. FIGS. 2-5 demonstrate that certain members, such as members 102A, 102B, and 103A, may have notches or indents that further increase plant and/or cage support and stability. The resulting structure 100 is compact and robust with short parallel insertion rods 101 that enable the cage to be quickly installed along a crop row fairly easily with little manual labor

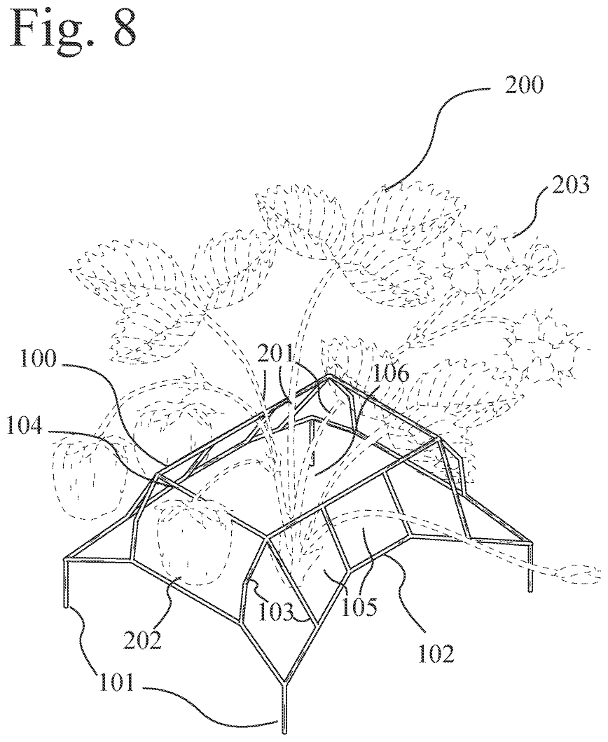

As shown in FIG. 8, the frame windows 105 and 106 allow the passage of sunlight and support the plant 200 by providing areas to rest and secure plant shoots 201, fruit 202, flowers 203, and/or other anatomical structures. The structure members that comprise the frames (members 102, 103 and 104) may support the weight of adjacent plant shoots and subsequently hold the plant in place, and may fortify the stem when subject to external forces from the environment (e.g., wind). This keeps the plant structures (201, 202, and 203) elevated, supporting them and maintaining them away from the ground and consequently protecting them from rot and pest consumption. This also alleviates the need for plants to be grown on mounds; the cage 100 enables the plants to be grown on flat ground without the concern of fruit becoming submerged in irrigation water or falling over.

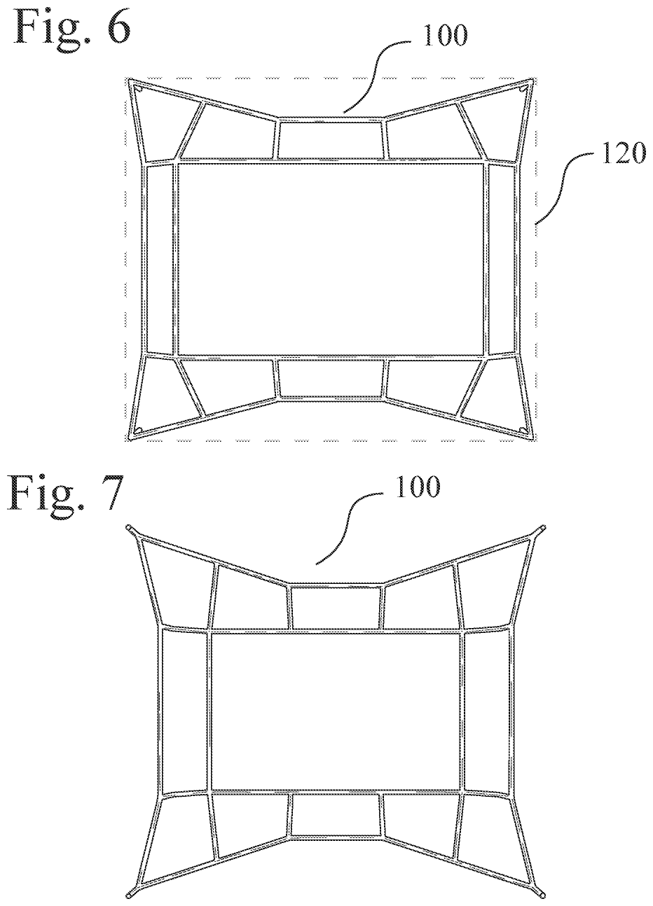

The dimensions of the plant support cage may vary depending on, but not limited to, the plant, the climate, or the incline of the ground. For example, as shown in FIG. 1 and FIG. 6, the present invention has a substantially rectangular outline 120. However, it should be noted that the height may be anywhere between 5-12 inches, provided that the cage maintains its compact and rigid structure; similarly, the width and length that may be up to approximately twice the height of the device. Furthermore, as shown in FIG. 1-8, the present invention has frame windows 105 and 106 that have a polygonal shape and varying sizes within approximately one square foot. It should be understood that the frame windows may be any suitable shape or size that allows for easy passage of the plant's shoots and provide support.

The plant growing cage 100 can be used in methods of growing low-lying plants, such as fruit-bearing plants, which facilitates growing such plants on flat ground without the plants or fruit being damaged by contact with ground or pooled irrigation water. The method may include preparing a substantially flat area of soil for growing plants, planting one or more low-lying plants (e.g., strawberry plants, tomatoes, etc.) in the prepared soil, waiting for the plant to sprout, and placing on of the plant growing cage 100 over the one or more low-lying plants. The windows 105 and 106 in the plant growing cage 100 are arranged in an encompassing pattern that capture the shoots of the one or more fruit-growing plants, including those that grow semi-laterally, as the lateral windows 105 have lower borders that are close to the ground. The windows 105 and 106 may then support and train the shoots of the plant to prevent growth too near the ground. A plant-growing cages 100 can be efficiently inserted into the prepared soil (e.g., creating a crop row) as the cage requires only vertical motion to insert the vertical insertion rods 101 into the soil.

Once the plants have grown fruit, the cages 100 support the fruit-bearing shoots, such that the fruit remains suspended over the ground, avoiding contact with the soil and pooled irrigation water, thereby avoid spoilage of the fruit. The fruit may be harvested, and the yield from the plants may be improved as fewer fruit have wasted on the ground. Once the fruit have been harvested, the plant support cages 100 can be quickly removed from the soil by simply vertically lifting the cage 100. The cages 100 can then be efficiently stored by stacking one upon another as each cage has the same concave construction allowing for stacking.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A low-profile plant support device for supporting growth of low-lying plants, comprising:
a plurality of corner insertion rods for insertion into soil;
a plurality of lateral shoot-support windows operable to allow the passage of shoots of a low-lying plant to support the weight of the shoot and prevent kinking of the shoots; and
at least one upward facing window operable to train vertical growth of shoots therethrough and reduce lateral collapsing of the shoots,
wherein the plurality of lateral windows and the at least one upward facing window are operable to support the weight of shoots bearing fruit.

2. The device of claim 1, wherein the device has a vertical height in a range of about 5 inches to about 12 inches.

3. The device of claim 1, wherein the device has a substantially rectangular outline.

4. The device of claim 1, wherein the plurality of vertical supports and cross members have notches or indentations that further increase plant and/or device stability.

5. The device of claim 1, wherein said plant support device includes at least six lateral shoot-support windows.

6. The device of claim 1, wherein said plant support device includes at least eight lateral shoot-support windows.

7. The device of claim 1, wherein said plant support device includes vertical supports on at least one side that have a convex outward bend therein to assist in preventing inward collapse of said plant support device.

8. The device of claim 1, wherein said lateral shoot-support windows comprises at least one corner shoot-support windows located at a corner of said plant support device having a three-dimensional polygonal structure.

9. The device of claim 8, wherein said three-dimensional polygon structure has an acute angle in a corner portion from which the one of said insertion corner rods is attached, wherein said acute angle assists in preventing inward collapse of said corner portion of said plant support device.

10. The device of claim 1, wherein the at least one upward facing window comprises a plurality of upward facing windows.

11. A method of growing low-lying plants, comprising:
a. planting seeds of low-lying plants on substantially flat soil;
b. placing a plant-support cage over said seeds or sprouts of said low-lying plants, said plant-support cage comprising
i. a plurality of corner insertion rods for insertion into soil,
ii. a plurality of lateral shoot-support windows operable to allow the passage of shoots of a low-lying plant to support the weight of the shoot and prevent kinking of the shoots, and
iii. at least one upward facing window operable to train vertical growth of shoots therethrough and reduce lateral collapsing of the shoots, wherein the shallow corner insertion rods can be quickly inserted into the soil with application of a downward force of about 10 pounds or less,
c. harvesting said low-lying plants; and
d. removing said plant-support cages.

12. The method of claim 11, further comprising stacking said plant-support cages in a nesting manner, wherein said plant-support cages have a geometry that allows a plurality of the plant-support cages to be stacked in a nested manner.

13. The method of claim 11, wherein a vertical height of said plant-support cage is in a range of about 5 inches to about 12 inches.

14. The method of claim 11, wherein the plant-support cage has a substantially rectangular outline.

15. The method of claim 11, wherein the plurality of vertical supports and cross members have notches or indentations that further increase plant and/or device stability.

16. The method of claim 11, wherein said plant support device includes at least six lateral shoot-support windows.

17. The method of claim 11, wherein said plant support device includes at least eight lateral shoot-support windows.

18. The method of claim 11, wherein said plant support device includes vertical supports on at least one side that have a convex outward bend therein to assist in preventing inward collapse of said plant support device.

19. The method of claim 11, wherein said lateral shoot-support windows comprises at least one corner shoot-support windows located at a corner of said plant support device having a three-dimensional polygonal structure.

20. The device of claim 19, wherein said three-dimensional polygon structure has an acute angle in a corner portion from which the one of said insertion corner rods is attached, wherein said acute angle assists in preventing inward collapse of said corner portion of said plant support device.

21. (canceled)

22. (canceled)

23. (canceled)

24. (canceled)

25. (canceled)
